(19) United States
(12) Patent Application Publication
(10) Pub. No.: US 2017/0266068 A1
(43) Pub. Date: Sep. 21, 2017

(54) CHAIR-TO-TABLE PROCEDURE APPARATUS AND METHOD FOR REVERSIBLE USE

(71) Applicant: MEDICAL POSITIONING, INC., KANSAS CITY, MO (US)

(72) Inventors: DAVID SCOTT, OVERLAND PARK, KS (US); GHASSAN DINN, KANSAS CITY, MO (US); ZOUHAIR TALBI, PRAIRIE VILLAGE, KS (US)

(73) Assignee: MEDICAL POSITIONING, INC., KANSAS CITY, MO (US)

(21) Appl. No.: 15/458,218

(22) Filed: Mar. 14, 2017

Related U.S. Application Data
(60) Provisional application No. 62/308,408, filed on Mar. 15, 2016.

(51) Int. Cl. A61G 5/00; A61G 13/12; A61G 5/10; A61G 13/10; A61G 13/04; A61G 13/08

(52) U.S. Cl. CPC A61G 5/006; A61G 13/04; A61G 13/08; A61G 5/101; A61G 13/104; A61G 13/129

(57) ABSTRACT

One embodiment of the present invention is directed to a convertible chair-to-table apparatus configured for reversible use. The apparatus may have a headrest on the leg board of the chair to enable a patient to use the chair with the patient's torso on the leg board. The invention is also directed to a method of using the apparatus by moving a patient's torso between the leg board and the back board of the apparatus.

### CROSS-REFERENCE TO RELATED APPLICATIONS

This application is based on and claims priority to U.S. Provisional Application Ser. No. 62/308,408, filed on Mar. 15, 2016, which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention is directed to the field of movable patient chairs convertible to a patient table for use in medical procedures, analysis and treatments.

2. Description of Related Art

Treatment rooms in hospitals and clinics are often very small. Many procedures, analysis and treatments also require the use of a medical device, such as a mammography and biopsy devices, and require the patient to be lying on their back or side on a table. The technician may be required to access both sides of the patient, which can be quite difficult in the small space, often requiring the technician to reach over the patient to access the second side while utilizing the medical device. Moving the table and/or medical devices often requires that the table and//or device be removed from the room and returned in a different position, which is inconvenient and inefficient.

### BRIEF SUMMARY OF THE INVENTION

Certain aspects of the present invention are directed to a convertible chair-to-table apparatus having a back board with a first headrest, a first headrest mount, or both, wherein the back board comprises a back board recess; a seat board pivotally connected to the back board; a leg board pivotally connected to the seat board, wherein the leg board is narrower than the seat board; and a base supporting the seat board. The leg board comprises a second headrest mount, and the apparatus is in a chair configuration when the back board is pivoted above the plane of the seat board and the leg board is pivoted below the plane of the seat board. The leg board may comprise a footrest mount. The apparatus may further comprise a back board insert having a shape complimentary to the back board recess and positioned within the back board recess and planar to the back board.

In certain aspects of the invention, the apparatus further comprising a second headrest operably connected to the second headrest mount. The second headrest mount may be configured to maintain the second headrest at a position less than 45 degrees from parallel above the leg board.

Other aspects of the invention are directed to an apparatus wherein the back board recess is along a first edge of the back board; a first edge of the leg board is narrower than a first edge of the seat board; and the first edge of the back board, the first edge of the leg board, and the first edge of the seat board are along a first edge of the apparatus. The first edge of the leg board may be at least three inches narrower than the first edge of the seat board, or at least five inches narrower than the first edge of the seat board.

Yet other aspects of the invention are directed to an apparatus comprising a second back board recess along a second edge of the back board, which second edge of the back board is opposite the first edge of the back board; and wherein a second edge of the leg board, opposite the first edge of the leg board, is narrower than a second edge of the seat board, which second edge of the seat board is opposite the first edge of the seat board. The second edge of the leg board is at least three inches narrower than the second edge of the seat board, or at least five inches narrower than the second edge of the seat board.

In certain aspects of the invention the seat board is tapered along the first edge of the seat board to form a seat board recess extending inwardly from the first edge of the seat board. The taper along the first edge of seat board may extend inwardly at least three inches from the first edge of the seat board and may extend inwardly at least five inches from the first edge of the seat board. In certain aspects of the invention, the seat board is tapered along the second edge of the seat board to form a second seat board recess extending inwardly from the second edge of the seat board.

In certain aspects of the invention, the seat board is configured to pivot along a horizontal access, such that when the seat board, back board and leg board are in the table configuration, the plane of the seat board, back board and leg board is able to pivot along a horizontal axis, such that the back board or leg board tilts below the horizontal axis.

Certain aspects of the invention are directed to a method for reversibly positioning a patient on a convertible chair-to-table apparatus comprising providing a convertible chair-to-table apparatus wherein the apparatus comprise a back board, wherein the back board comprises a back board recess; a seat board pivotally connected to the back board; a leg board pivotally connected to the seat board, wherein the leg board is narrower than the seat board; and a base supporting the seat board; and a headrest.

Such aspect further comprises locating the back board and leg board planar to the seat board; placing the headrest in a position relative to the leg board to receive a head of the patient; and positioning the patient on the apparatus with the patient's legs on the back board and the patient's torso on the leg board; wherein the narrow leg board allows access to the patient's torso.

In certain aspects the method further comprises the step of resting the patient's head on the headrest.

In certain aspects the method further comprises the step of removing a footrest from, or stowing the footrest on, the leg board.

In certain aspects the method further comprises, after the positioning step, repositioning the patient on the apparatus with the patient's legs on the leg board and the patient's torso on the back board.

In other aspects, the method further comprises, after the locating step and before the positioning step, the additional step of laying a patient on the apparatus with the patient's legs on the leg board and the patient's torso on the back board, and wherein the positioning step comprises repositioning the patient.

In certain aspects of the invention, the step of locating the back board and leg board comprises raising the leg board to a horizontal position and lowering the back board to the horizontal position.

In yet other aspects of the invention, the method further comprises, after the positioning step, tilting the planar seat board, back board and leg board along a horizontal axis to lower the patient's head below horizontal.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of an apparatus of the present invention in the table configuration, with a second headrest mounted on the leg board.

FIG. 2 is a perspective view of an apparatus of the present invention in the chair configuration.

FIG. 3 is a perspective view of the apparatus of FIG. 2 the table configuration.

FIG. 4 is a perspective view of one embodiment of a headrest mount.

FIG. 5 is a perspective view of an apparatus of the present invention in the table configuration showing the footrest removed from the leg board and the second headrest ready to be installed on the leg board.

FIG. 6 is a side elevational view of an apparatus of the present invention in the table configuration with a headrest positioned at an angle above parallel and a footrest positioned at an angle below perpendicular.

FIG. 7 is a top view of one embodiment of a footrest mounting holes in the leg board of an apparatus of the present invention.

FIG. 8 is a side view showing an apparatus of the present invention in an inclined position.

### DETAILED DESCRIPTION OF PREFERRED EMBODIMENTS

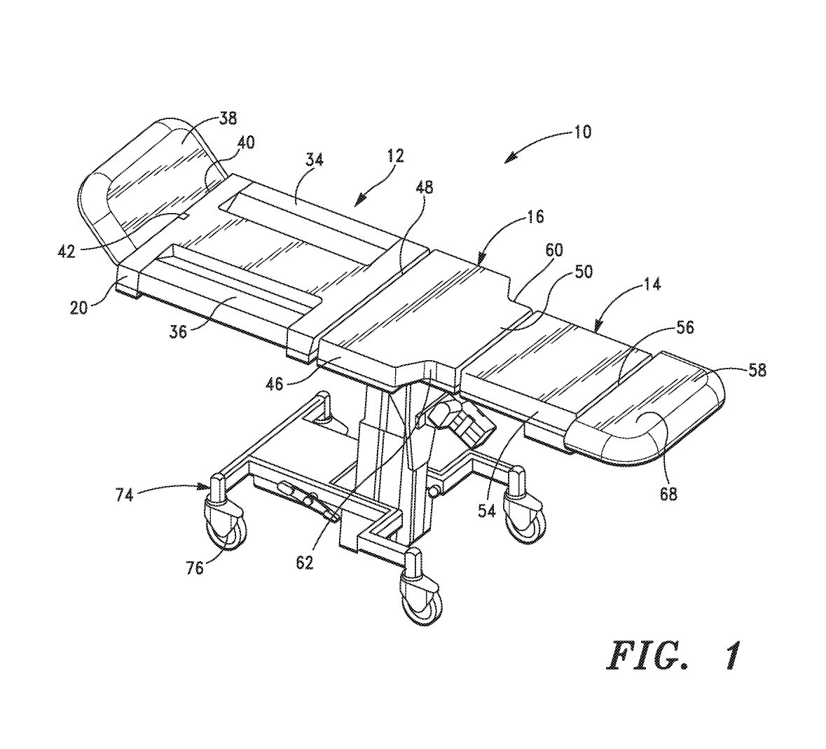

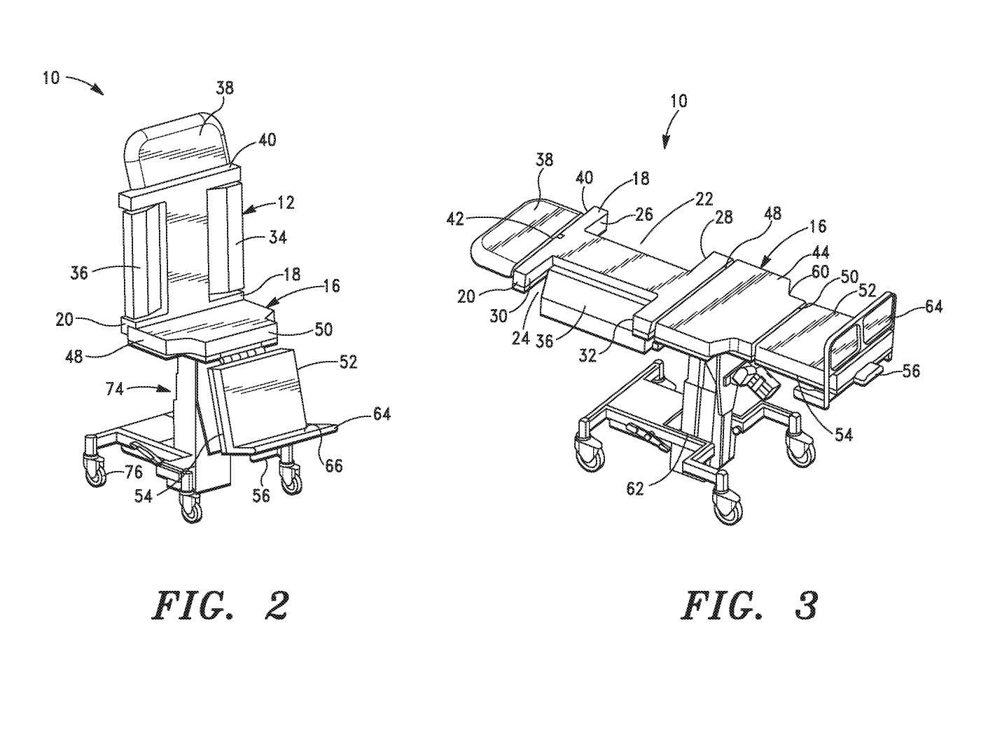

One embodiment of the present invention is directed to a convertible chair-to-table apparatus 10 configured for reversible use. As shown if FIG. 1, apparatus 10 comprises a back board 12 and leg board 14 pivotally mounted to seat board 16. Apparatus 10 can be converted from the chair configuration depicted in FIG. 2 to a table configuration depicted in FIG. 3 by pivoting back board 12 above the plane of the seat board 16 and pivoting leg board 14 below the plane of the seat board 16. Seat board 16 is in a generally horizontal position in both the chair and table configurations. Apparatus 10 can be returned to a chair configuration by reversing the movements. Suitable pivotal attachment arrangements for moving the back board and leg board to convert an ambulatory chair to a procedure table are well known in the art.

When apparatus 10 is in the table configuration of FIG. 1, the patient can be positioned with the torso on either the back board 12 or leg board 14, which allows access to both sides of the patient while the patient remains facing the same side of apparatus 10. This allows the technician or physician to access both sides of the patient's torso without having to reach over or around the patient or rotate apparatus 10. Instead the patient reverses position from head-to-foot on apparatus 10.

Turning to FIG. 3, back board 12 is configured with opposing first edge 18 and second edge 20. Back board 12 preferably comprises one or more back board recesses 22 and 24 along first edge 18 and/or second edge 20, preferably one back board recess 22 along first edge 18 and one back board recess 24 along second edge 20. Back board recess 22 and 24 are of sufficient depth and length to allow access to a patient supported on back board 12 by a technician or a medical device. The apparatus of the present invention can be used with a wide variety of medical device and procedures. In certain embodiments, apparatus 10 is particularly suited for use with mammography and biopsy devices, such as the GE Senographe Essential Stereotaxy system and the Hologic Selenia Dimensions mammography system.

Back board recesses are preferably at least 10 inches in length, more preferably at least 20 inches in length, and are preferably between 10 and 30 inches in length, any length or range within such range, or longer. In one exemplary embodiment back board recesses 22 and 24 are 22 inches in length. In embodiments having more than one back board recess, back board recesses can be the same or different lengths. Back board recesses 22 and 24 can be any shape that allows access to the patient. Back board recesses 22 are preferably at least 2 inches deep, preferably at least 5 inches deep and in certain embodiments are between 2 and 12 inches deep our any depth or range of depths therebetween.

Back board recesses 22 and 24 can comprise ends 26, 28, 30 and 32 defined by back board 12 as depicted in the Figures. Alternatively, back board recesses can extend the entire length of back board 12. In such embodiments, the depth of the back board recess is the depth the first and second edges 18 and 20 are recessed from first and second edges of seat board 16.

Back board 12 preferably comprises back board inserts 34 and 36 complimentary in size and shape to back board recesses 22 and 24. Back board inserts 34 and 36 can be removably or pivotally mounted in back board recesses 22 and 24 to allow access to recesses 22 and 24 by the technician or a medical device. Various types of back board inserts and attachments are known in the art, and exemplary back board recesses and back board inserts are described as access sites and filler sections, respectively, in U.S. Pat. No. 6,557,196 to Falbo, Sr. et al., U.S. Pat. No. 5,950,262 to Smoler et al., and U.S. Pat. No. 5,184,363 to Falbo, Sr., each of which is incorporated by reference with respect to such disclosure.

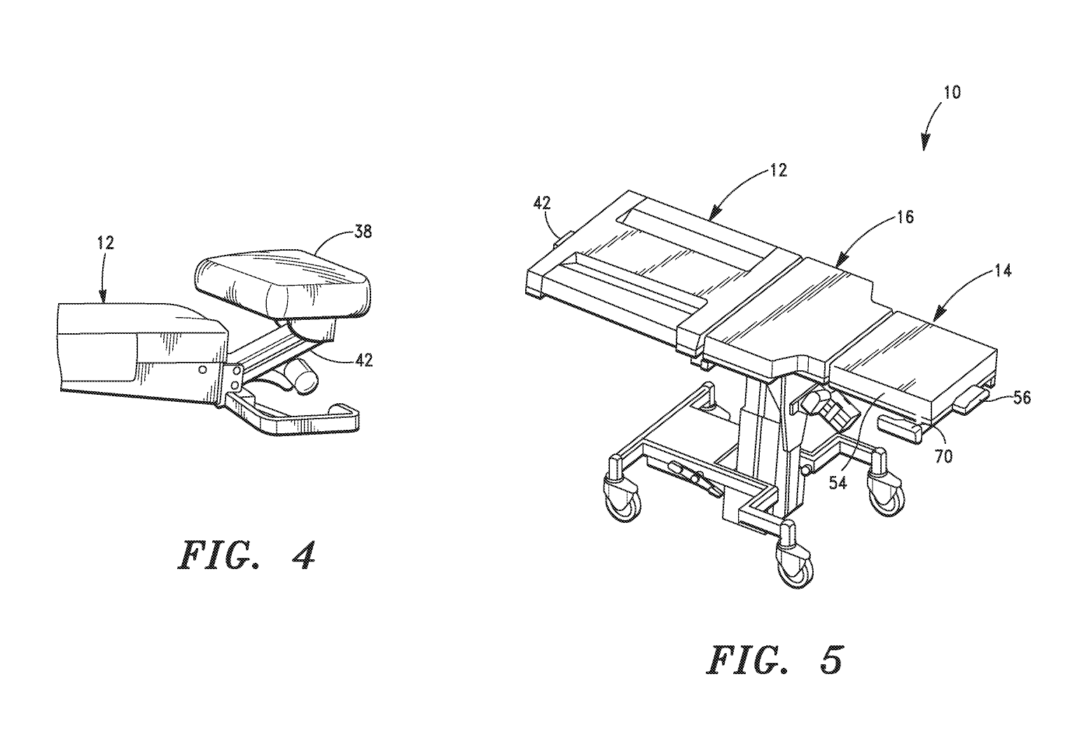

Back board 12 preferably includes a headrest 38 extending from distal end 40 of back board 12 for supporting the patient's head. Headrest 38 can be any extension of the length of back board 12 sufficient to support a patient's head. Headrest 38 may be permanently or removably affixed to distal end 40 by a headrest mount 42. Headrest mount 42 encompasses any connection point or interface between headrest 38 and back board 12. Headrest mount 42 may include a mount onto or into which headrest 38 can be removably attached, a mount permanently attaching headrest 38 to back board 12 or a mount forming an integral connection between headrest 38 and back board 12. FIG. 4 shows one embodiment of a headrest mount 42 extending between headrest 38 and back board 12.

The term “headrest mount” encompasses any and all portions of the interface between back board 12 and headrest 38, including elements of back board 12 to which headrest 38 or other elements of the headrest mount are connected, extensions between the back board and the headrest, and similar elements. In certain embodiments, such as that shown in FIG. 4, headrest mount 42 comprises a headrest extension member between the back board 12 and headrest 38. The headrest extension member may be integral with or affixed to the headrest. In certain embodiments, the headrest mount comprises openings in or attachments to back board 12 to which the extension member or headrest is removably or permanently attached.

Also, although headrest 38 extends past distal end 40 of back board 12, a first end of headrest mount 42 may originate at any point on back board 12, or even any point on apparatus 10, and extend beyond distal end 40 of back board 12. In certain embodiments, back board 12 does not comprise a headrest mount, in which case the headrest is provided by back board 12 being of sufficient length to support a patient's head, in which case back board 12 serves as the headrest. In such embodiment, the headrest may be combined with another support element extending from the surface of back board 12 to support the patient's head.

Back board 12 is of a size and general shape suitable for supporting the torso of a horizontal patient when apparatus 10 is in the table configuration and for supporting the back of a seated patient when apparatus 10 is in the chair configuration. In certain embodiments, back board 12 may be from 20 to 40 inches in length along first and second edges 18 and 20, preferably between 25 and 35 inches in length. In embodiments where the length of back board 12 serves as the headrest, back board 12 is preferably at least 30 inches and up to 50 inches or more in length. The width of back board 12 between first and second edges 18 and 20, including any back board inserts, is preferably between 20 and 40 inches wide.

Returning to FIGS. 1, 2 and 3, seat board 16 is of a size and general shape suitable for supporting a seated patient when apparatus 10 is in the chair configuration. Seat board 16 has opposing first and second edges 44 and 46 generally parallel to first and second edges 18 and 20 of back board 12 and has first and second ends 48 and 50, where first end 48 is adjacent to back board 12 and second end 50 is adjacent to leg board 14. In certain embodiments, seat board 16 is between 10 and 30 inches long, along edges 44 and 46 and between 20 and 40 inches wide between edges 44 and 46.

Leg board 14 is of a size and general shape large enough to support the torso of a horizontal patient when apparatus 10 is in the table configuration, is of a length short enough to allow apparatus 10 to serve as a chair when leg board 14 is lowered from horizontal in the chair configuration, and is sufficiently narrow to allow a technician or medical device to access the patient when apparatus 10 is in the table configuration. Such combination of features and requirements is uniquely associated with the chair-to-table apparatus of the present invention that allows both conversion between chair and table configurations, as well as reversible positioning of the patient on the table, in which the torso can be placed on either back board 12 or leg board 14.

Leg board 14 has opposing first and second edges 52 and 54 generally parallel to first and second edges 18 and 20 of back board 12 and first and second edges 44 and 46 of seat board 16. The width of leg board 14 between first and second edges 52 and 54 is narrower than the width of seat board 16 between first and second edges 44 and 46. This provides access sites for a technician or medical device to access the torso of the patient when the patient's torso is positioned on leg board 14 and the patient's feet are on back board 12. To allow such access, first edge 52 and/or second edge 54 of leg board 14 may be at least 3 inches narrower than first edge 44 and/or second edge 46, respectively, of seat board 16. Preferably each of first edge 52 and/or second edge 54 of leg board 14 is at least 5 inches narrower and up to 12 inches narrower than first edge 44 and/or second edge 46, respectively of seat board 16, or any value or range between 3 and 12 inches. In certain embodiments, leg board 14 is between 10 and 30 inches wide. Because of the length requirements of leg board 14, in most embodiments leg board 14 will not be of sufficient length to allow inserts, similar to back board inserts 34 and 36, to be placed in the access sites created by narrow leg board 14.

As noted above, leg board 14 cannot be so long as to prevent practical use of apparatus 10 as a chair. If leg board 14 is too long, it would require seat board 16 to be positioned so high as to prevent practical use as a chair. Preferably leg board 14 is less than 24 inches long, preferably between 10 and 24 inches long.

Because of the unique requirements for the apparatus of the present invention to convert from a chair configuration to a reversible table configuration, in order to support the head of an average or above-average sized patient, leg board 14 includes a second headrest mount 56 for removably or stowably attaching second headrest 58 to leg board 14. Second headrest mount 56, and its relation to leg board 14, can be similar to headrest mount 42, and it relation to back board 12, discussed above, with the important exception that second headrest mount 56 must allow removable attachment or stowage of second headrest 58. Second headrest 58, and its relation to leg board 14, can be similar to headrest 38, and its relation to back board 12, discussed above, with the important exception that second headrest 58 cannot be formed solely from an extension of the length of leg board 14. By “stowably” or “stowable” it is meant that headrest mount 56 may be configured so that second headrest 58 may remain attached to leg board 14 when apparatus 10 is in the chair configuration, but headrest 38 is pivoted, slid, folded or otherwise moved to a position that does not interfere with the ability of the user's legs to rest against leg board 14 when seated on apparatus 10 in the chair configuration or interfere with any footrest that may be attached to leg board 14. The terms stowably and stowable refer to similar attachments when used to describe other elements of the apparatus.

Although first and second edges 44 and 46 of seat board 16 are preferably generally straight, first and/or second edges 44 and 46 of seat board 16 may taper inward at second end 50 of seat board 16 to form one or more seat recesses 60 and 62. The taper may be a gradual taper, a sharp 90 degree angle or any other shape that provides a recess along first and/or second edges 44 and 46 of seat board 16 adjacent second end 50 of seat board 16 and a first end of leg board 14. Seat recesses 60 and 62 enable the length of the access site formed by narrow leg board 14 to be extended into seat board 16. The depth of seat recesses 60 and 62 preferably corresponds to the difference between the width of seat board 16 and the width of leg board 14. The length of seat recesses 60 and 62 is preferably greater than 2 inches, more preferably between 2 and 5 inches.

Also, although first and second edges 52 and 54 of leg board 14 are generally straight, a portion of first and/or second edge 52 and 54 can be wider, provided the wide section does not prevent access to the patient through the access sites produced by the narrow leg board 14.

In certain embodiments, a footrest 64 is removably or stowably attached to the lower end of leg board 14. In such embodiments, footrest 64 must be able to be removed from leg board 14, or otherwise stowed with respect to leg board 14, to allow a patient's torso to rest on leg board 14 without footrest 64 interfering with the patient's head. FIG. 5 depicts one exemplary embodiment showing footrest 64 removed from leg board 14.

Footrest 64 and footrests of the prior art generally differ from headrest 38 and second headrest 58 in several material respects. Headrest 38 and second headrest 58 are preferably made from a material that is comfortable on which to rest the patient's head, whereas footrests are generally made of a rigid and durable material, such as metals (e.g. aluminum or steel) or hard plastic, which are designed to withstand being stepped on and kicked by a patient's feet. Such materials are generally not suitable for a headrest.

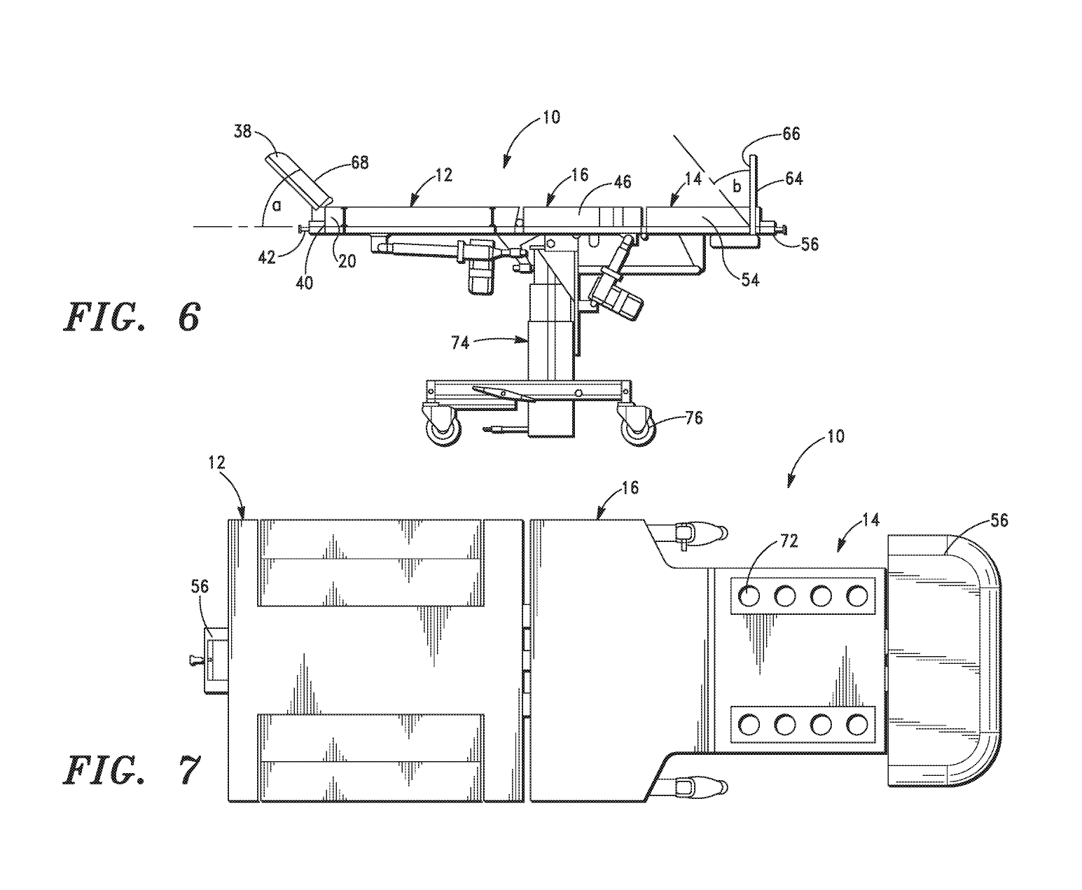

Further, headrest 38 and second headrest 58 may be configured with a concave surface or otherwise shaped to generally complement the shape of a patient's head. In contrast, footrests are generally planar to allow stable contact with the lower surface of a patient's foot. Further, headrest 38 and second headrest 58 are generally positioned with an upper surface 68 at a position that is parallel (FIG. 1) or angled above parallel (FIG. 6) from the surface of back board 16 or leg board 14, and can even be below parallel. FIG. 6 depicts apparatus 10 in which upper surface 68 headrest 38 is at an angle a above parallel. Angle a is preferably less than 45 degrees, more preferably less than 30 degrees. In contrast, footrests 64 are generally are generally perpendicular to the surface of leg board 14, as shown in FIGS. 2 and 3, or at an angle, b, away from perpendicular, toward the surface of leg board 14 as shown in FIG. 6. Angle b is preferably less than 45 degrees to provide a stable surface on which to rest the patient's feet. Footrest 64 can also be angled away from perpendicular away from the surface of leg board 14.

Although certain characteristics of a footrest will make it unsuitable for use as second headrest 58, it is contemplated that footrest can serve both as a footrest and a headrest if its characteristics are modified to be suitable for use as a headrest. For example, an attachment that serves at a footrest when positioned perpendicular to leg board 14 could be converted to a headrest if pivoted back to within 45 degrees of being parallel to leg board 14. At such time, the element ceases to be a footrest and is converted to a headrest in such position.

Footrest 64 can be removably or stowably attached to leg board 14 by various mechanisms. In the exemplary embodiment of FIG. 5, one or more footrest mounting plates 70 extend along edges 52 and 54 of leg board 14. Mounting plates 70 contain holes into which footrest 64 can be mounted. Mounting plates 70 may be configured to fold behind, slide into or otherwise stow with respect to leg board 14 or be removed when footrest 64 is not attached so as not to interfere with the access sites created by the narrow leg board 14.

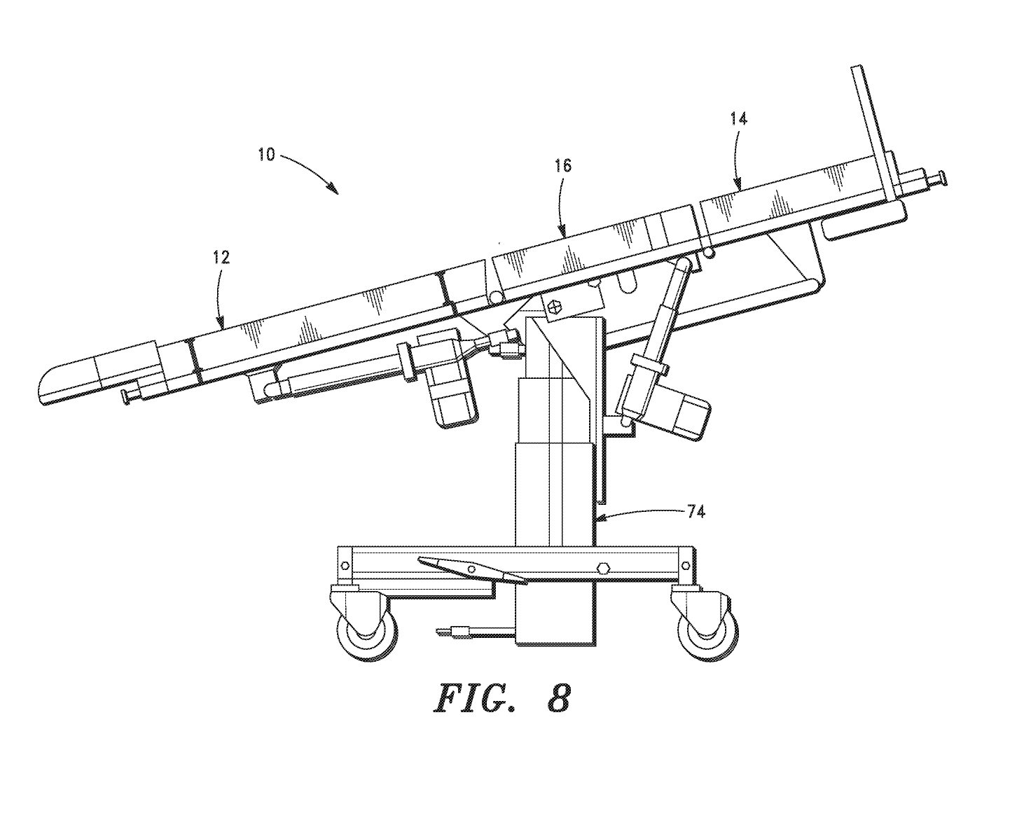

In one alternative embodiment shown in FIG. 7, leg board 14 comprises footrest mounting holes 72 located within leg board 14 having a fixed location that does not interfere with the access sites created by the narrow leg board 14. Mounting holes 72 may be covered with upholstery when not in use to mount footrest 64.

Headrest 38 and second headrest 58 can be narrower or wider than back board 12 and leg board 14, respectively. In one embodiment, shown in FIG. 7, second headrest 58 is wider than leg board 14, which can provide additional support to the shoulders of a patient lying with the torso on leg board 14. Headrest 38 and second headrest 58 can be the same width and can be interchangeable. In addition, headrest 38 and second headrest 58 can be configured to move side to side along the edge of back board 12 or leg board 14, respectively.

Apparatus 10 is supported above the floor by base 74 preferable located under seat board 16. Base 74 may be any support capable of supporting the patient on the apparatus. Preferably base 74 includes a plurality of wheels 76 to allow apparatus 10 to be moved when in the table or chair configurations, with wheel brakes to allow apparatus 10 to be safely maintained in a fixed location. Suitable bases 74 and wheels 76 are well-known in the art.

Apparatus 10 may be configured to allow the patient to be positioned at various angles of incline and decline. For example, when apparatus 10 is in the table configuration and back board 12, leg board 14 and seat board 16 are generally planar, seat board 16 may be tilted relative to base 74, causing the plane of back board 12, leg board 14 and seat board 16 to incline or decline to thereby either raise lower back board 12 and lower leg board 14, or raise leg board 14 and lower back board 12, in Trendelenburg or Reverse Trendelenburg position, as shown in FIG. 8. Mechanisms for tilting a table in such manner are disclosed in U.S. Pat. No. 6,353,949 to Falbo, which is incorporated herein by reference for such disclosure.

While multiple dimensions and embodiments for various components are provided, it is to be understood that all are sized and configured to support a human patient thereon in both the chair and table configurations. The term “board” when used herein with respect to the back board, leg board and seat board broadly refers to a generally planar support member that can be comprised of any materials or combination of materials known in the art or suitable for medical tables and/or convertible ambulatory chairs. When used herein the term “horizontal” means generally or substantially horizontal and sufficiently horizontal that the patient will not roll off the apparatus.

One embodiment of the present invention is directed to a method for reversibly positioning a patient on a convertible chair-to-table apparatus. The apparatus of the present invention is put in the table configuration by locating the back board and leg board planar to the seat board, preferably by raising the leg board to a horizontal position and lowering the back board to the horizontal position. In certain uses of an apparatus of the invention, the patient will already be seated on the apparatus before it is put into the table configuration, and the patient remains on the apparatus during the conversion. However, is most uses, the apparatus will be moved to the table configuration before the patient is seated or the patient may be removed from the apparatus prior to the conversion to the table configuration.

A headrest is placed in a position relative to the leg board to receive the head of the patient. This can involve affixing a removable headrest to the leg board or unstowing a stowed headrest.

The patient is positioned on the apparatus with the patient's legs on the back board and the patient's torso on the leg board, such that the narrow leg board allows access to the patient's torso. In most uses, the patient will have been lying on the apparatus with the patient's legs on the leg board and the patient's torso on the back board, such that the positioning step is actually repositioning the patient so that the patient's head is where the patient's legs were previously located. However, if the patient was not seated on the chair during the conversion to the table configuration, the patient can be positioned on the apparatus from a standing position, with the patient's torso on the back board or leg board.

It should be understood that the positioning and repositioning steps can be performed in any order and the patient may be repeatedly repositioned between a first position with the torso on the back board and a second position with the torso on the leg board. This allows any desired treatment, analysis or testing to be performed between positioning and repositioning steps. Any positioning or repositioning step can include resting the patient's head on the headrest.

In embodiments of the apparatus of the present invention comprising a footrest, the method includes removing or stowing the footrest prior to positioning the patient's torso on the leg board.

In certain embodiment the method includes tilting the planar seat board, back board and leg board along a horizontal axis to lower the patient's head below horizontal. Because the seat board, back board and leg board are in a planar configuration tilting any one section tilts all sections. The apparatus may be tilted so that the back board can be tilted below horizontal or the leg board can be tilted below horizontal, thus allowing the head to be tilted below horizontal in the Trendelenburg position when the torso is on the back board or on the leg board.

It should be understood that the terms used with respect to the method, including positioning, lying, resting, locating, placing and repositioning, include a technician or other party physically moving the patient into the position or instructing the patient to take such position, either verbally or in writing.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A convertible chair-to-table apparatus comprising:
a back board having a first headrest, a first headrest mount, or both, wherein the back board comprises a back board recess;
a seat board pivotally connected to the back board;
a leg board pivotally connected to the seat board, wherein the leg board is narrower than the seat board; and
a base supporting the seat board;
wherein the leg board comprises a second headrest mount;
wherein the apparatus is in a chair configuration when the back board is pivoted above the plane of the seat board and the leg board is pivoted below the plane of the seat board.

2. The apparatus of claim 1, further comprising a second headrest operably connected to the second headrest mount.

3. The apparatus of claim 1, wherein the second headrest mount is configured to maintain the second headrest at a position less than 45 degrees from parallel above the leg board.

4. The apparatus of claim 1, wherein:
the back board recess is along a first edge of the back board;
a first edge of the leg board is narrower than a first edge of the seat board;
and the first edge of the back board, the first edge of the leg board, and the first edge of the seat board are along a first edge of the apparatus.

5. The apparatus of claim 4, wherein the first edge of the leg board is at least three inches narrower than the first edge of the seat board.

6. The apparatus of claim 5, wherein the first edge of the leg board is at least five inches narrower than the first edge of the seat board.

7. The apparatus of claim 4, comprising a second back board recess along a second edge of the back board, which second edge of the back board is opposite the first edge of the back board; and wherein a second edge of the leg board, opposite the first edge of the leg board, is narrower than a second edge of the seat board, which second edge of the seat board is opposite the first edge of the seat board.

8. The apparatus of claim 7, wherein the second edge of the leg board is at least three inches narrower than the second edge of the seat board.

9. The apparatus of claim 8, wherein the second edge of the leg board is at least five inches narrower than the second edge of the seat board.

10. The apparatus of claim 4, wherein the seat board is tapered along the first edge of the seat board to form a seat board recess extending inwardly from the first edge of the seat board.

11. The apparatus of claim 10, wherein the taper along the first edge of seat board extends inwardly at least three inches from the first edge of the seat board.

12. The apparatus of claim 11, wherein the taper along the first edge of seat board extends inwardly at least five inches from the first edge of the seat board

13. The apparatus of claim 7, wherein the seat board is tapered along the second edge of the seat board to form a second seat board recess extending inwardly from the second edge of the seat board.

14. The apparatus of claim 1, wherein when the seat board, back board and leg board are in the table configuration, and the seat board is configured to pivot along a horizontal access to allow the plane of the seat board, back board and leg board to pivot along a horizontal axis, such that the back board or leg board tilts below the horizontal axis.

15. The apparatus of claim 1, wherein the leg board comprises a footrest mount.

16. The apparatus of claim 1, further comprising a back board insert having a shape complimentary to the back board recess and positioned within the back board recess and planar to the back board.

17. A method for reversibly positioning a patient on a convertible chair-to-table apparatus comprising:
providing a convertible chair-to-table apparatus comprising:
a back board, wherein the back board comprises a back board recess;
a seat board pivotally connected to the back board;
a leg board pivotally connected to the seat board, wherein the leg board is narrower than the seat board; and
a base supporting the seat board; and
a headrest;
locating the back board and leg board planar to the seat board;
placing the headrest in a position relative to the leg board to receive a head of the patient; and
positioning the patient on the apparatus with the patient's legs on the back board and the patient's torso on the leg board;
wherein the narrow leg board allows access to the patient's torso.

18. The method of claim 17, further comprising the step of resting the patient's head on the headrest.

19. The method of claim 17, further comprising the step of removing a footrest from, or stowing the footrest on, the leg board.

20. The method of claim 17, further comprising after the positioning step, repositioning the patient on the apparatus with the patient's legs on the leg board and the patient's torso on the back board.

21. The method of claim 17, further comprising after the locating step and before the positioning step, the additional step of laying a patient on the apparatus with the patient's legs on the leg board and the patient's torso on the back board, and wherein the positioning step comprises repositioning the patient.

22. The method of claim 17, wherein locating the back board and leg board comprises raising the leg board to a horizontal position and lowering the back board to the horizontal position.

23. The method of claim 17, further comprising after the positioning step, tilting the planar seat board, back board and leg board along a horizontal axis to lower the patient's head below horizontal.
